(19) United States
(12) Patent Application Publication
(10) Pub. No.: US 2026/0350099 A1
(43) Pub. Date: Nov. 5, 2026

(54) INFORMATION PROCESSING APPARATUS, SOCIAL VR SYSTEM, INFORMATION PROCESSING METHOD, AND RECORDING MEDIUM

(71) Applicant: NEC Corporation, Tokyo (JP)

(72) Inventor: Shogo MATSUO, Tokyo (JP)

(73) Assignee: NEC Corporation, Tokyo (JP)

(21) Appl. No.: 19/487,655

(22) PCT Filed: Jun. 12, 2024
(86) PCT No.: PCT/JP2024/021269

§ 371 Date: Nov. 25, 2025

(30) Foreign Application Priority Data
Jun. 13, 2023 (JP) 2023-096810

(51) Int. Cl. G06F 16/906; G06Q 10/44; G06T 11/00

(52) U.S. Cl. CPC G06F 16/906; G06Q 10/44; G06T 11/00

(57) ABSTRACT

Provided is an information processing device, etc., with which it is possible to provide a virtual space in which a user can easily find an unknown user who has the same interests or concerns as the user. This information processing device includes: a section information acquisition means for acquiring section information relating to a section in a virtual space; a group detection means for detecting a group formed by a plurality of users for each section; a group feature quantity extraction means for extracting a group feature quantity, which is a feature quantity of the group; and a tag display means for displaying, for each section, a tag that displays the group feature quantity.

### TECHNICAL FIELD

The present disclosure relates to an information processing apparatus, a social VR system, an information processing method, and an information processing program.

### BACKGROUND ART

In recent years, communication utilizing virtual spaces on the Internet has become increasingly active. In the use of a virtual space, for example, an avatar representing a user is generated in the virtual space. Then, in the virtual space, the avatar and an avatar of another user communicate with each other. This enables communication of a plurality of users via the virtual space. Methods for supporting such communication are being studied.

For example, PTL 1 discloses a technique for controlling communication between avatars in accordance with a distance in a virtual space. In this technique, first, a unique region is set around each avatar. Then, a session of message exchange is then established when the unique region of one's avatar overlaps with the unique region of another user's avatar. This technique enables communication between users whose avatars are nearby in the virtual space.

PTL 2 discloses a technique for supporting communication between a plurality of avatars gathered for a specific purpose. In this technique, first, the character information of the characters (avatars) gathered at the party in the virtual space is displayed at a predetermined position on the display screen. Text information input for each character is displayed in a region adjacent to the character information. As a result, it is described that the information required by the player (user) is accurately displayed in a realistic manner. In this case, it is described that the operability of the game is not impaired.

### CITATION LIST

### Patent Literature

PTL 1: JP 2003-067317 A

PTL 2: JP 2014-023940 A

### SUMMARY OF INVENTION

### Technical Problem

In the technique of PTL 1 described above, the avatars that can be newly found are limited to the avatars that have been close on the virtual space. Therefore, the user of the other avatar does not necessarily have the same interests or concerns as oneself. That is, there is a problem that the probability of meeting a user having the same interests or concerns as oneself is affected by chance.

In the technique of PTL 2, users to be encountered are limited to users who agree with a preset purpose. For this reason, there is a problem that there are few opportunities to encounter an unknown user having the same interests or concerns as oneself.

The present invention has been made in view of the above problems, and an object thereof is to provide an information processing apparatus or the like capable of providing a virtual space in which a user can easily find an unknown user having the same interests or concerns as oneself.

### Solution to Problem

In order to solve the above problems, an information processing apparatus of the present disclosure includes: a section information acquisition means for acquiring section information related to a section in a virtual space; a group detection means for detecting a group formed by a plurality of users for each section; a group feature amount extraction means for extracting a group feature amount that is a feature amount of the group; and a tag display means for displaying a tag displaying the group feature amount for each section.

A social virtual reality (VR) system of the present disclosure includes the above-described information processing apparatus and a virtual space generation server that generates the virtual space.

In an information processing method of the present disclosure, an information processing apparatus: acquires section information related to a section in a virtual space; detects a group formed by a plurality of members for each section; extracts a group feature amount that is a feature amount of the group; and displays a tag displaying the group feature amount for each section.

An information processing program of the present disclosure causes a computer to execute: a process of acquiring section information related to a section in a virtual space; a process of detecting a group formed by a plurality of members for each section; a process of extracting a group feature amount that is a feature amount of the group; and a process of displaying a tag displaying the group feature amount for each section.

### Advantageous Effects of Invention

An effect of the present invention is to provide an information processing apparatus or the like capable of providing a virtual space in which a user can easily find an unknown user having the same interests or concerns as oneself.

### BRIEF DESCRIPTION OF DRAWINGS

FIG. 1 is a block diagram illustrating an example of an information processing apparatus.

FIG. 2 is a block diagram illustrating an example of a social VR system.

FIG. 3 is a flowchart illustrating an example of operation of an information processing apparatus.

FIG. 4 is a block diagram illustrating an example of a group feature amount extraction means.

FIG. 5 is a schematic diagram illustrating an example of display of a virtual space.

FIG. 6 is a block diagram illustrating an example of a participant user feature amount extraction means.

FIG. 7 is a block diagram illustrating an example of a behavior history feature amount extraction means.

FIG. 8 is a block diagram illustrating an example of a hardware configuration of an information processing apparatus.

FIG. 9 is a block diagram illustrating an example of an information processing apparatus according to a modification.

FIG. 10 is a block diagram illustrating an example of a player feature amount extraction means.

FIG. 11 is a flowchart illustrating an example of operation of an information processing apparatus according to a modification.

### EXAMPLE EMBODIMENT

Hereinafter, example embodiments of the present invention will be described in detail with reference to the drawings. However, the example embodiments described below have technically preferable limitations for carrying out the present disclosure, but the scope of the disclosure is not limited to the following. Similar components in drawings are denoted by the same reference numerals, and description thereof may be omitted.

### First Example Embodiment

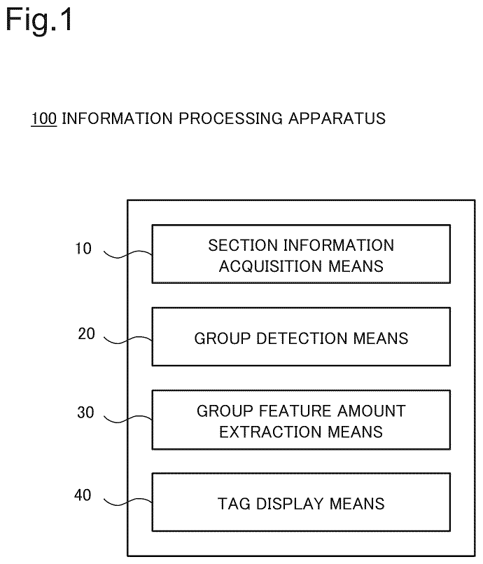

FIG. 1 is a block diagram illustrating an example of an information processing apparatus 100. The information processing apparatus 100 includes a section information acquisition means 10, a group detection means 20, a group feature amount extraction means 30, and a tag display means 40.

The section information acquisition means 10 acquires section information related to a section on the virtual space. A section is set to specify a place on the virtual space. When the section information acquisition means 10 acquires the section information, it is possible to associate other information with a place in the virtual space. For example, the virtual space is divided into a lattice shape to form sections.

The group detection means 20 detects groups formed by a plurality of users for each section. Here, in the present example embodiment, for example, it is assumed that users can communicate with each other by the following mechanism.
Each user uses an avatar movable in the virtual space.
As one avatar and another avatar approach each other, communication between the avatars (users) becomes possible.
Examples of the communication method include a conversation by voice, exchange of a text message, sharing of a file, and the like.

The group detection means 20 detects that data related to communication as described above has been generated. Then, the formation of the group is detected by this detection. As described above, in the virtual space of the present example embodiment, communication becomes possible by the avatars approaching each other. Therefore, each group is associated with a section in the virtual space. That is, various groups can be formed for each section.

When the group is detected, the group feature amount extraction means 30 extracts the group feature amount of each group. Although a specific group feature amount will be described later, for example, a matter that is a topic in the group, an attribute common to users forming the group, or the like is the group feature amount.

Then, the tag display means 40 displays the tag displaying the extracted group feature amount in the section.

In the above configuration, the user can easily find a group that matches his/her interests or concerns. The reason is as follows. When the virtual space is large and the number of participants increases, it is difficult to find a section in which a group having interests or concerns matching one's own is present. In a method where contact is made indiscriminately with nearby groups, it takes time for the user to confirm whether the topic of the group matches his/her interests or concerns. Furthermore, there is a possibility that the user participates in a conversation that the user does not want to be involved with.

On the other hand, in the configuration of the present example embodiment, the user can easily grasp the feature of the group formed in each section by looking at the tag. As a result, the user can easily find the group having interests or concerns matching one's own.

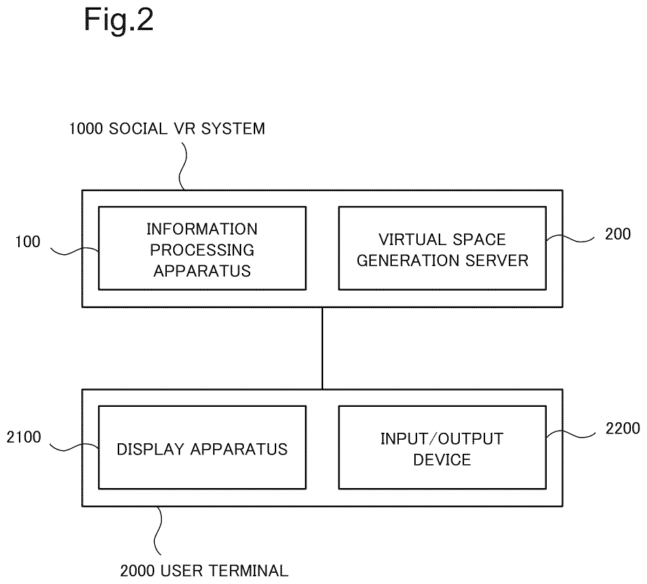

FIG. 2 is a block diagram illustrating an example of a social VR system 1000. The social VR system 1000 includes the information processing apparatus 100 and a virtual space generation server 200 of the present example embodiment.

The virtual space generation server 200 generates a virtual space. The virtual space is divided into sections related to addresses of the real space. The virtual space generation server 200 generates and controls the avatar in response to a request of the user. In the virtual space, an environment that enables communication between avatars (users) is provided. For example, communication becomes possible when one avatar and another avatar approach each other within a predetermined contactable distance. The communication means is, for example, exchange of a text message, a conversation by voice, display of a file, or the like. Then, the information processing apparatus 100 displays the tag indicating the group feature amount in each section. In the virtual space, objects such as natural terrains such as a mountain and a sea, a building, a store, a station, and an item may be generated.

A user accesses the social VR system 1000 by using the user terminal 2000. Then, the user logs in to the virtual space using the avatar. The user terminal 2000 has a calculation function, a storage function, and a communication function of functions of a general computer. The user terminal 2000 includes a display apparatus 2100 and an input/output device 2200. The display apparatus 2100 and the input/output device 2200 may be separate bodies. The display apparatus 2100 and the input/output device 2200 may be integrated. The display apparatus 2100 is, for example, a head mount display (HMD) or a flat panel display. By using the HMD, the immersive feeling and the realistic feeling of the user are enhanced.

The user operates the input/output device 2200 to control the avatar in the virtual space. For example, when the user operates the input/output device 2200, the movement of the avatar in the virtual space is executed. For example, the input/output device 2200 includes an audio input unit and a speaker, thereby enabling input/output of voice. As a result, for example, a conversation by voice can be performed in the virtual space.

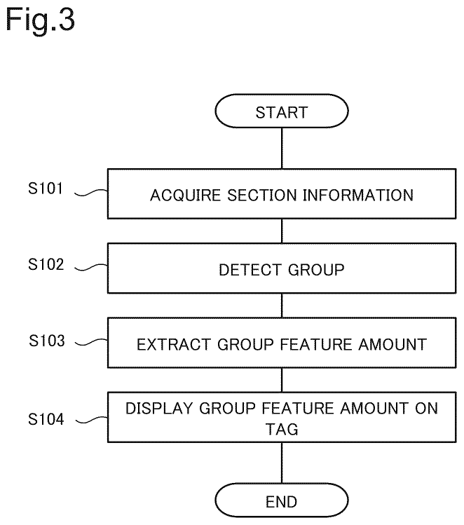

Next, the operation of the information processing apparatus 100 will be described. FIG. 3 is a flowchart illustrating an example of the operation of the information processing apparatus 100. First, the information processing apparatus 100 acquires section information from the virtual space generation server 200 (S101). Next, the group detection means 20 detects groups formed in sections (S102). At this time, users participating in each group are also identified. The user information is held in, for example, the virtual space generation server 200. In this way, in the information processing apparatus 100, the formed group is identified in association with the section. Then, the group feature amount extraction means 30 acquires user information of users participating in each group. Next, the group feature amount extraction means 30 extracts the feature amount of each group. The feature amount of the group is extracted as a group feature amount (S103). Details of the group feature amount will be described later. Next, the extracted group feature amount is displayed in the virtual space as a tag (S104). For example, the extraction of the group feature amount is repeated at a predetermined extraction cycle. The tag display is updated at a predetermined update cycle, for example.

As described above, according to the configuration of the present example embodiment, the feature of the group formed in each section is displayed on the tag. By referring to this tag, the user can easily find a group having interests or concerns matching one's own.

### Specific Example 1

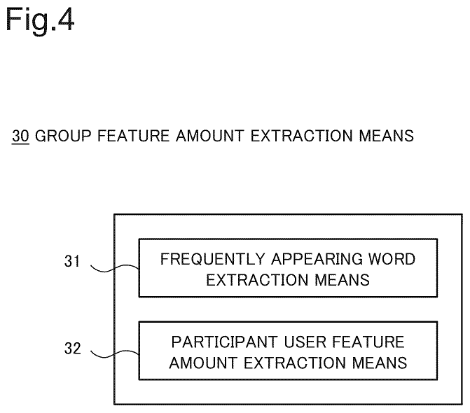

Next, a specific example of the group feature amount and the group feature amount extraction means 30 will be described. FIG. 4 is a block diagram illustrating an example of a group feature amount extraction means. The group feature amount extraction means 30 of the present example includes a frequently appearing word extraction means 31 and a participant user feature amount extraction means 32.

The frequently appearing word extraction means 31 extracts words that frequently appear in communication of a group formed in a certain section. First, in a predetermined frequently appearing word extraction period, the frequently appearing word extraction means 31 records a word appearing in a message or a conversation. In a case where a conversation by voice is performed, the frequently appearing word extraction means 31 records characters obtained by converting the spoken words. Next, the recorded words are ranked according to the appearance frequency. Then, a predetermined number of words are selected as frequently appearing words to be displayed on the tag in descending order of rank.

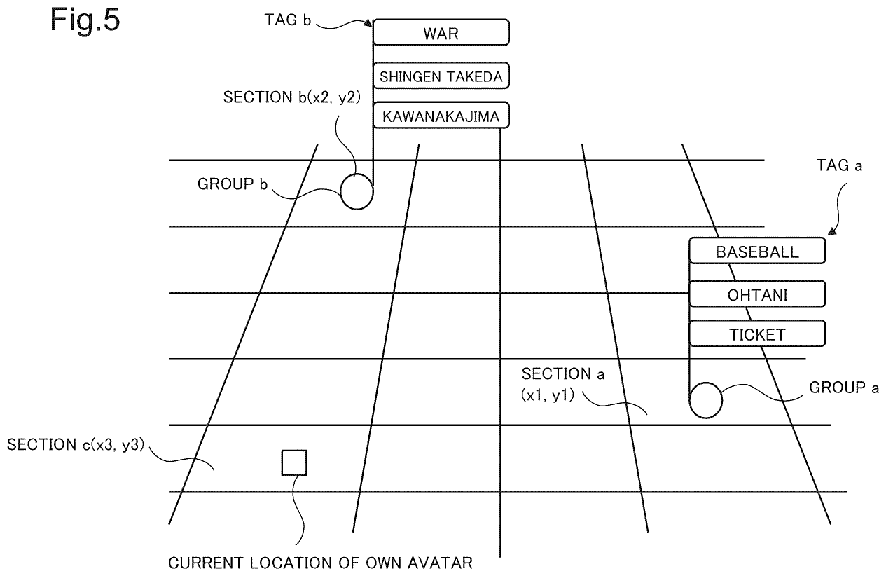

FIG. 5 is a schematic diagram illustrating an example of display of a virtual space. The virtual space is divided into grid-like sections. Then, a group a is formed in the section a(x1, y1). A group b is formed in the section b(x2, y2). Here, the avatar of the user (himself/herself) is in a section c(x3, y3) away from the sections a and b. Then, in the section a, “war,” “Shingen Takeda,” and “Kawanakajima” extracted as the frequently appearing words are displayed in the tag a. In the section b, “baseball,” “Ohtani,” and “ticket” are displayed in the tag b. By referring to these tags, the user can easily find a group having interests or concerns matching one's own. Then, when the user moves to a section of interest, communication with the group formed therein becomes possible.

### Specific Example 2

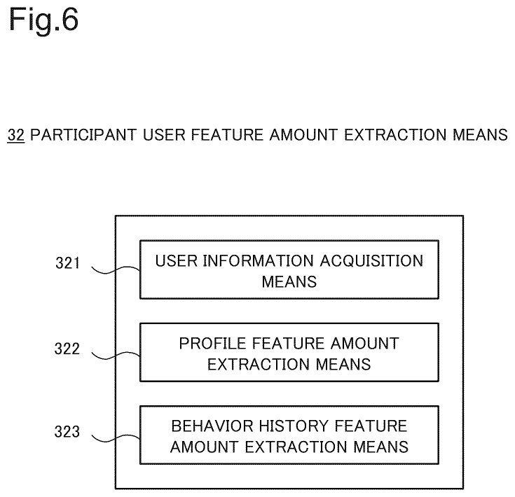

The group feature amount may include a feature amount common to users participating in each group. Then, the participant user feature amount extraction means 32 extracts the feature amount as the participant user feature amount. £ The feature amount of the user includes a feature amount of a profile of the user and a feature amount of a behavior of the user. Therefore, the participant user feature amount extraction means 32 extracts the profile feature amount and the behavior feature amount. For this purpose, the participant user feature amount extraction means 32 includes a user information acquisition means 321. The participant user feature amount extraction means 32 includes a profile feature amount extraction means 322. The participant user feature amount extraction means 32 includes a behavior history feature amount extraction means 323. FIG. 6 is a block diagram illustrating an example of the participant user feature amount extraction means 32.

The user information acquisition means 321 acquires user information of a user participating in a group. For example, the user information is acquired from the virtual space generation server 200. Here, for example, user information is held in the social VR system 1000. For example, in using the social VR system 1000, each user registers his/her own profile information in the system. The profile information includes, for example, a hobby, a matter of interest or concern, and the like.

The profile feature amount extraction means 322 extracts a profile common to users participating in the group. For example, in a certain group, if many users have watching baseball games registered as a hobby in their profile information, watching baseball games is extracted as profile information of the group. In a case where there are many users whose interests and concerns include mountain climbing, the mountain climbing is extracted as profile information of this group. Then, the profile information is ranked in descending order of the number of common users. Next, a predetermined number of pieces of profile information are extracted as the profile feature amount displayed on the tag in descending order of ranking.

When each piece of user information includes the behavior history of the user, the behavior history feature amount is extracted. The behavior history feature amount is a feature amount of a behavior history common to users participating in the group. The behavior history feature amount extraction means 323 extracts a behavior history feature amount. This behavior history is a behavior history in the virtual space.

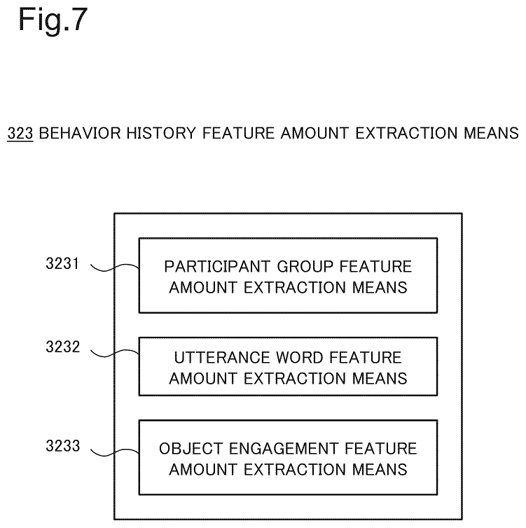

FIG. 7 is a block diagram illustrating an example of the behavior history feature amount extraction means 323. The behavior history feature amount extraction means 323 includes a participant group feature amount extraction means 3231, an utterance word feature amount extraction means 3232, and an object engagement feature amount extraction means 3233.

The participant group feature amount extraction means 3231 extracts a participant group feature amount related to a group in which each user has participated in the past. For example, the group staying in the past, the group feature amount of the group, and the stay time of the user in the group are included in the behavior feature amount. Then, for example, the groups are ranked according to the stay time, and the feature amount of the upper group is extracted as the participant group feature amount.

The utterance word feature amount extraction means 3232 extracts the feature amount of the word uttered by each user. For example, here, words that frequently appear in a message that each user has uttered by text or voice are included in the utterance word feature amount. That is, ranks are assigned to the words uttered in the message exchange performed in the group according to the number of appearances. Then, a word with a high rank is extracted as an utterance word feature amount.

The behavior history may include engagement of each user with an object in the virtual space. The object engagement feature amount extraction means 3233 extracts the feature amount of engagement with the object. The feature amount of engagement with the object is extracted as the object engagement feature amount. Examples of the object include natural terrains such as a mountain and a sea, a building, a store, a station, and an item. Then, the user's engagement with the object includes, for example, contact with the object, user's gaze at the object, and the like. Then, the engagement with the object is ranked according to, for example, the number of times of engagement, the engagement time, and the like. In one example, the feature amount is ranked by the accumulated engagement time in which the engagement time is accumulated, and the feature amount with a high rank is extracted as the object engagement feature amount.

The participant group feature amount, the utterance word feature amount, and the object engagement feature amount described above are added to the tag. Then, the tag is displayed in the section.

As described above, according to the configuration of the second specific example, the profile or the behavior history that is the personality of each user constituting the group is reflected in the group feature amount. Then, the group feature amount is displayed as a tag. Therefore, the user who has newly logged in to the virtual space can easily find a group suitable for his/her interests or concerns.

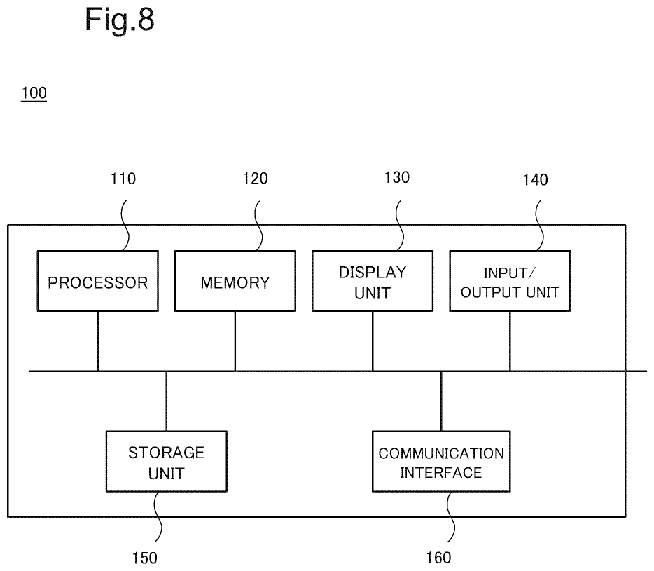

Next, a hardware configuration of the information processing apparatus 100 will be described. FIG. 8 is a block diagram illustrating an example of a hardware configuration of the information processing apparatus 100.

The information processing apparatus 100 is implemented in, for example, a general computer. Then, this computer includes, for example, a processor 110, a memory 120, a display unit 130, an input/output unit 140, a storage unit 150, and a communication interface 160. The processor 110 performs calculation necessary for information processing such as tag display. The memory 120 stores data used for calculation. The display unit 130 displays data and images. The input/output unit 140 is a device that inputs and outputs data. The input/output unit 140 includes, for example, a keyboard, a mouse, an audio signal output unit, a print signal output unit, and the like. The storage unit 150 stores data. The communication interface 160 performs communication interface processing. The hardware configuration as described above enables control necessary for information processing.

### Modification

In the first specific example and the second specific example, the method of displaying the feature amount of the group in each section with a tag has been described. In this method, in a case where the group feature amounts of all the groups are displayed as tags, when the number of formed groups increases, the number of tags also increases. Then, when the number of tags becomes enormous, it becomes difficult for the user who is searching for a participant group to search for a group matching his/her interests or concerns. Therefore, in the modification, a configuration for narrowing down the tags to be displayed will be described. In the following description, in order to distinguish between a user who is already participating in a group and a user who is searching for a participant group, a user who is considering participation is referred to as a player.

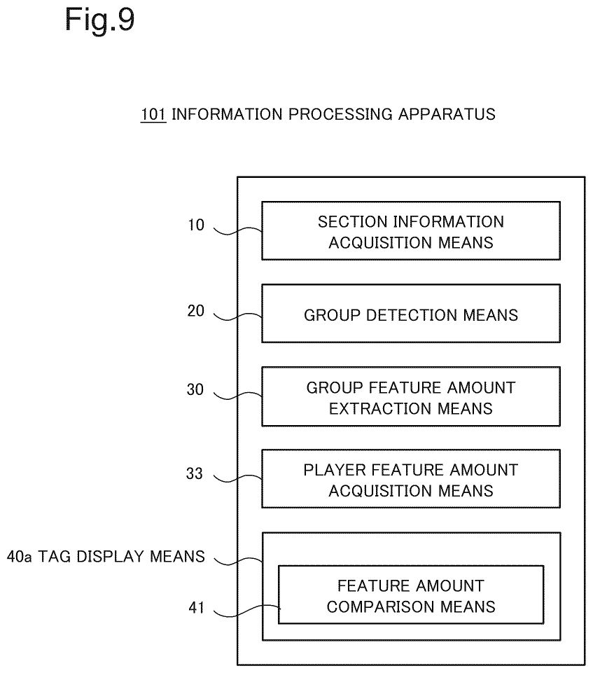

FIG. 9 is a block diagram illustrating an example of an information processing apparatus 101 according to a modification. Similarly to the information processing apparatus 100, the information processing apparatus 101 includes a section information acquisition means 10, a group detection means 20, and a group feature amount extraction means 30. In addition, a player feature amount acquisition means 33 is provided. A tag display means 40a includes a feature amount comparison means 41. Description of the same configuration as the information processing apparatus 100 will be omitted.

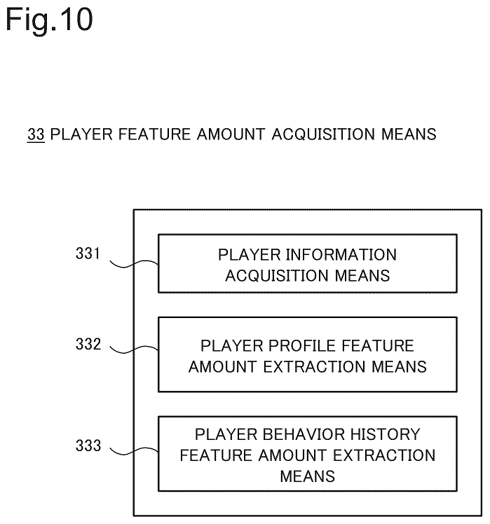

The player feature amount acquisition means 33 acquires the player feature amount. FIG. 10 is a block diagram illustrating an example of the player feature amount acquisition means 33. The player feature amount acquisition means 33 includes a player information acquisition means 331, a player profile feature amount extraction means 332, and a player behavior history feature amount extraction means 333.

The player information acquisition means 331 acquires the player information. The player information is information similar to the user information in the information processing apparatus 100. That is, the player information includes the profile information of the player and the behavior history of the player in the virtual space. The player information is held in, for example, the virtual space generation server 200. Alternatively, the player information may be held in the user terminal 2000. Then, the player information acquisition means 331 acquires the player information.

The player profile feature amount extraction means 332 extracts a player profile feature amount from the acquired player information. The player profile feature amount includes, for example, a hobby registered by the player, a matter of interests or concerns, and the like.

The player behavior history feature amount extraction means 333 extracts a behavior history feature amount from the acquired player information. This behavior history is a behavior history of the player in the virtual space. The player behavior history feature amount is similar to the behavior history feature amount of the user in the information processing apparatus 100. That is, the behavior history feature amount includes, for example, the participant group feature amount of the player, the utterance word feature amount of the player, and the object engagement feature amount.

The participant group feature amount is a feature amount of a group in which the player stayed in the past. For example, the groups are ranked according to the stay time of the player, and the feature amount of the upper group is extracted as the participant group feature amount.

The player behavior history feature amount extraction means 333 extracts the feature amount of the word uttered by the player. In the virtual space, the player issues a message by text or voice. For example, the player behavior history feature amount extraction means 333 extracts words that frequently appear in the messages which the player has sent in the past. That is, the words are ranked according to the number of appearances among the messages uttered by the player. Then, a word with a high rank is extracted as an utterance word feature amount.

The behavior history may include the player's engagement with the object in the virtual space. The player behavior history feature amount extraction means 333 extracts the feature amount of engagement with the object. For example, an object having a long accumulated engagement time of the player is extracted as the object engagement feature amount.

The player behavior history feature amount extraction means 333 extracts the player behavior history feature amount including the participant group feature amount, the utterance word feature amount, and the object engagement feature amount described above.

With the above configuration, the player feature amount acquisition means 33 acquires the player feature amount. Next, the feature amount comparison means 41 compares the group feature amount with the player feature amount. Next, the feature amount comparison means 41 sets a group having a group feature amount matching the player feature amount as a tag display candidate. Then, the tag display means 40a displays the feature amount of the group set as the tag display candidate on the tag.

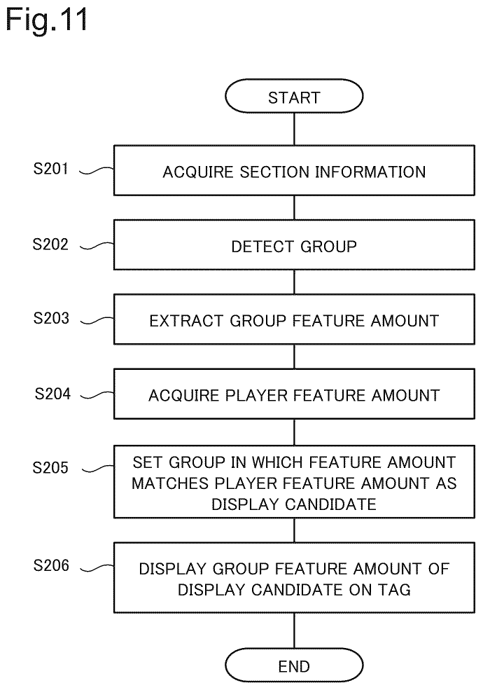

FIG. 11 is a flowchart illustrating an example of the operation of the information processing apparatus 101 according to the modification. First, the information processing apparatus 101 acquires section information of the virtual space (S201). Next, the group detection means 20 detects groups formed in sections (S202). Next, the group feature amount extraction means 30 extracts feature amounts of groups. This feature amount is extracted as a group feature amount (S203). Next, the player feature amount acquisition means 33 acquires the player feature amount (S204). Next, the feature amount comparison means 41 compares the player feature amount with the group feature amount. Then, the feature amount comparison means 41 sets a group whose group feature amount matches the player feature amount as a tag display candidate (S205). Next, the tag display means 40a displays the group feature amount of the group of tag display candidates on the tag in the virtual space (S206). In the above operation, only the tag of the group having the group feature amount matching the player feature amount is displayed in the virtual space. Therefore, the groups for which the tags are displayed are narrowed down to groups for which the player has interests or concerns.

As described above, according to the information processing apparatus 101 of the modification, the groups for which the tags are displayed in the virtual space are narrowed down to the groups for which the player has interests or concerns. Therefore, it is easy to search for a group for which the player has interests or concerns.

The information processing apparatus and the like of the present example embodiment have been described above.

The information processing apparatus 100 according to the present example embodiment includes the section information acquisition means 10, the group detection means 20, the group feature amount extraction means 30, and the tag display means 40. The section information acquisition means 10 acquires section information related to a section in the virtual space. The group detection means 20 detects a group formed by a plurality of users for each section. The group feature amount extraction means 30 extracts a group feature amount which is a feature amount of the group. The tag display means 40 displays a tag for displaying the group feature amount for each section.

With the above configuration, the feature amount of the group formed on the virtual space is displayed on the tag for each section. By referring to this tag, a user who searches for a group can easily find a target group.

According to an aspect, in the information processing apparatus 100, the group feature amount includes words that frequently appear in message exchange in each of the groups.

With the above configuration, the words being discussed in each group are displayed on the tags. Therefore, it is easy to find a group that is discussing matters of interest or concern to oneself.

According to an aspect, in the information processing apparatus 100, the feature amount of the group includes a participant user feature amount. The participant user feature amount is extracted from the user information of each user participating in the group.

According to the above configuration, the features of the users participating in each group are displayed on the tags. Therefore, it is easy to find a group in which users having common interests or concerns with oneself are gathered.

According to an aspect, in the information processing apparatus 100, the user information includes profile information set in advance by the user.

According to the above configuration, the feature of the profile of the user participating in each group is displayed on the tag. For this reason, it is easy to find a group in which users meeting their preferences are gathered.

According to an aspect, in the information processing apparatus 100, the user information includes behavior history information regarding a behavior history of the user in the virtual space.

According to the above configuration, the features of the behavior histories of the users participating in each group are displayed on the tags. For this reason, it is easy to find a group in which users engaging in behavior that suits their preference are gathered.

According to an aspect, in the information processing apparatus, the behavior history includes past utterance content of the user.

According to the above configuration, the features of the past utterance contents of the users participating in each group are displayed on the tags. For this reason, it is easy to find a group in which users who make remarks suitable for their preference are gathered.

According to an aspect, the information processing apparatus 101 includes the player feature amount acquisition means 33 and the feature amount comparison means 41. The player is a user who searches for the group suitable for the purpose. The player feature amount acquisition means 33 acquires the player feature amount related to the player. The feature amount comparison means 41 compares the player feature amount with the group feature amount. Then, the tag display means 40a displays the tag of the group having the group feature amount matching the player feature amount.

In the above configuration, only the tags of the groups having the group feature amounts matching the feature amounts of the player are displayed in the virtual space. Therefore, the groups for which the tags are displayed are narrowed down to groups for which the player has interests or concerns. Therefore, the player can easily find the group in which the player wants to participate.

The social VR system 1000 of the present example embodiment includes the information processing apparatus 100 and the virtual space generation server 200 described above. The virtual space generation server 200 generates a virtual space. Here, VR is an abbreviation of virtual reality.

With the above configuration, it is easy for the user (player) who is searching for a group with which he/she makes contact in the virtual space to search for a group that matches his/her preference.

In the information processing method of the present example embodiment, the information processing apparatus 100 acquires section information regarding a section in the virtual space. The information processing apparatus 100 detects a group formed by a plurality of users for each of the sections. The information processing apparatus 100 extracts a feature amount of the group. The information processing apparatus 100 displays a tag for displaying the feature amount of the group for each of the sections.

With the above configuration, the feature amount of the group formed on the virtual space is displayed on the tag for each section. By referring to this tag, a user who is searching for a group in which the user wants to participate can easily find a target group.

The information processing program of the present example embodiment causes a computer to execute processing of acquiring section information regarding sections in a virtual space, and processing of detecting a group formed by a plurality of users for each of the sections. The information processing program causes the computer to execute processing of extracting the feature amount of the group. The information processing program causes processing of displaying the tag for each section to be executed. At this time, the tag displays the feature amount of the group.

With the above configuration, the feature amount of the group formed on the virtual space is displayed on the tag for each section. By referring to this tag, the user who is searching for the group can easily find the target group.

A program for causing a computer to execute any of the processes disclosed above and a recording medium storing the program are also included in the scope of the present invention. As the recording medium, for example, a magnetic disk, a magnetic tape, an optical disk, a magneto-optical disk, a semiconductor memory, or the like can be used.

The present disclosure has been described above using the first example embodiment as an exemplary example. However, the present disclosure is not limited to the above example embodiments. That is, the present disclosure can apply various aspects that can be understood by those skilled in the art within the scope of the present disclosure.

A part or all of the above example embodiments can also be described as the following supplementary notes. However, the scope of the present disclosure is not limited to the following.

### Supplementary Note 1

An information processing apparatus including:
a section information acquisition means for acquiring section information related to a section in a virtual space;
a group detection means for detecting a group formed by a plurality of users for each section;
a group feature amount extraction means for extracting a group feature amount that is a feature amount of the group; and
a tag display means for displaying a tag displaying the group feature amount for each section.

### Supplementary Note 2

The information processing apparatus according to Supplementary Note 1, wherein
the group feature amount includes
a word frequently appearing in a message exchange in each group.

### Supplementary Note 3

The information processing apparatus according to Supplementary Note 1 or 2, wherein
the group feature amount includes
a participant user feature amount extracted from user information regarding each user participating in the group.

### Supplementary Note 4

The information processing apparatus according to Supplementary Note 3, wherein
the user information includes
a profile information set in advance by the user.

### Supplementary Note 5

The information processing apparatus according to Supplementary Note 3 or 4, wherein
the user information includes
behavior history information regarding a behavior history of the user in the virtual space.

### Supplementary Note 6

The information processing apparatus according to Supplementary Note 5, wherein
the behavior history includes
a past utterance content of the user.

### Supplementary Note 7

The information processing apparatus according to Supplementary Note 5 or 6, wherein
the behavior history includes
a history of engagement of the user with an object provided in the virtual space.

### Supplementary Note 8

The information processing apparatus according to any one of Supplementary Notes 1 to 7, further including:
a player feature amount acquisition means for acquiring a player feature amount related to a player who is a user searching for the group in which the user participates; and
a feature amount comparison means for comparing the player feature amount with the group feature amount, wherein
the tag display means
displays the tag of the group having the group feature amount matching the player feature amount.

### Supplementary Note 9

A social virtual reality (VR) system including:
the information processing apparatus according to any one of Supplementary Notes 1 to 8; and
a virtual space generation server that generates the virtual space.

### Supplementary Note 10

An information processing method including,
by an information processing apparatus:
acquiring section information related to a section in a virtual space;
detecting a group formed by a plurality of users for each section;
extracting a feature amount of the group; and
displaying a tag displaying the feature amount of the group for each section.

### Supplementary Note 11

An information processing program for causing a computer to execute:
a process of acquiring section information related to a section in a virtual space;
a process of detecting a group formed by a plurality of users for each section;
a process of extracting a feature amount of the group; and
a process of displaying a tag displaying the feature amount of the group for each section.

The present invention has been described above using the above-described example embodiments as exemplary examples. However, the present invention is not limited to the above-described example embodiments. That is, the present invention can apply various aspects that can be understood by those skilled in the art within the scope of the present invention.

This application is based upon and claims the benefit of priority from Japanese patent application No. 2023-096810, filed on Jun. 13, 2023, the disclosure of which is incorporated herein in its entirety by reference.

### REFERENCE SIGNS LIST

10 Section information acquisition means
20 Group detection means
30 Group feature amount extraction means
31 Frequently appearing word extraction means
32 Participant user feature amount extraction means
33 Player feature amount acquisition means
40,40a Tag display means
41 Feature amount comparison means
100, 101 Information processing apparatus
200 Virtual space generation server
1000 Social VR system
2000 User terminal
2100 Display apparatus
2200 Input/output device

What is claimed is:

1. An information processing apparatus comprising:
a memory configured to store instructions; and
at least one processor configured to execute the instructions to perform:
acquiring section information related to a section in a virtual space;
detecting a group formed by a plurality of users for each section;
extracting a group feature amount that is a feature amount of the group; and
displaying a tag displaying the group feature amount for each section.

2. The information processing apparatus according to claim 1, wherein
the group feature amount includes
a word frequently appearing in a message exchange in each group.

3. The information processing apparatus according to claim 1, wherein
the feature amount of the group includes
a participant user feature amount extracted from user information regarding each user participating in the group.

4. The information processing apparatus according to claim 3, wherein
the user information includes
a profile information set in advance by the user.

5. The information processing apparatus according to claim 3, wherein
the user information includes
behavior history information regarding a behavior history of the user in the virtual space.

6. The information processing apparatus according to claim 5, wherein
the behavior history includes
a past utterance content of the user.

7. The information processing apparatus according to claim 5, wherein
the behavior history includes
a history of engagement of the user with an object provided in the virtual space.

8. The information processing apparatus according to claim 1, wherein
the at least one processor is further configured to execute the instructions to perform:
acquiring a player feature amount related to a player who is a user searching for the group in which the user desires to participate; and
comparing the player feature amount with the group feature amount, wherein
the at least one processor is configured to execute the instructions to perform
displaying the tag of the group having the group feature amount matching the player feature amount.

9. A social virtual reality (VR) system comprising:
the information processing apparatus according to claim 1; and
a virtual space generation server that generates the virtual space.

10. An information processing method comprising,
by an information processing apparatus:
acquiring section information related to a section in a virtual space;
detecting a group formed by a plurality of users for each section;
extracting a group feature amount that is a feature amount of the group; and
displaying a tag displaying the group feature amount for each section.

11. The information processing method according to claim 10, wherein
the group feature amount includes
a word frequently appearing in a message exchange in each group.

12. The information processing method according to claim 10, wherein
the feature amount of the group includes
a participant user feature amount extracted from user information regarding each user participating in the group.

13. The information processing method according to claim 12, wherein
the user information includes
a profile information set in advance by the user.

14. The information processing method according to claim 12, wherein
the user information includes
behavior history information regarding a behavior history of the user in the virtual space.

15. The information processing method according to claim 14, wherein
the behavior history includes
a past utterance content of the user.

16. The information processing method according to claim 14, wherein
the behavior history includes
a history of engagement of the user with an object provided in the virtual space.

17. The information processing method according to claim 10, further comprising,
by an information processing apparatus:
acquiring a player feature amount related to a player who is a user searching for the group in which the user desires to participate;
comparing the player feature amount with the group feature amount; and
displaying the tag of the group having the group feature amount matching the player feature amount.

18. A recording medium that is non-transitory, the recording medium storing an information processing program for causing a computer to execute:
a process of acquiring section information related to a section in a virtual space;
a process of detecting a group formed by a plurality of users for each section;
a process of extracting a group feature amount that is a feature amount of the group; and
a process of displaying a tag displaying the group feature amount for each section.

19. The recording medium according to claim 18, wherein
the group feature amount includes
a word frequently appearing in a message exchange in each group.

20. The recording medium according to claim 18, wherein
the feature amount of the group includes
a participant user feature amount extracted from user information regarding each user participating in the group.

21. The recording medium according to claim 20, wherein
the user information includes
a profile information set in advance by the user.

22. The recording medium according to claim 20, wherein
the user information includes
behavior history information regarding a behavior history of the user in the virtual space.

23. The recording medium according to claim 22, wherein
the behavior history includes
a past utterance content of the user.

24. The recording medium according to claim 22, wherein
the behavior history includes
a history of engagement of the user with an object provided in the virtual space.

25. The recording medium according to claim 18, wherein
the information processing program causing the computer to execute:
acquiring a player feature amount related to a player who is a user searching for the group in which the user desires to participate;
comparing the player feature amount with the group feature amount; and
displaying the tag of the group having the group feature amount matching the player feature amount.
